(19) United States
(12) Patent Application Publication
(10) Pub. No.: US 2015/0277609 A1
(43) Pub. Date: Oct. 1, 2015

(54) TOUCH DATA SEGMENTATION METHOD OF TOUCH CONTROLLER

(71) Applicant: Samsung Electronics Co., Ltd., Suwon-si (KR)

(72) Inventors: Ji-sung JUNG, Suwon-si (KR); Hae-yong AHN, Hwaseong-si (KR); Jong-seon KIM, Seongnam-si (KR); Mi-hye JUNG, Suwon-si (KR); Hwi-taek CHUNG, Yongin-si (KR)

(21) Appl. No.: 14/644,963

(22) Filed: Mar. 11, 2015

(30) Foreign Application Priority Data
Apr. 1, 2014 (KR) 10-2014-0038753
Sep. 5, 2014 (KR) 10-2014-0118963

(51) Int. Cl. G06F 3/041

(52) U.S. Cl. CPC G06F 3/041

(57) ABSTRACT

In one embodiment, the touch controller receives touch signals transmitted by a touch panel so as to generate the touch data and perform segmentation based on a peak node of the touch data by assigning labels to neighboring nodes. The method includes determining whether nodes of the touch data are in a touch state by using an energy change of the touch data; selecting a peak node of the touch data; determining a state of the touch data by tracking the peak node; and performing segmentation based on the peak node.

### CROSS-REFERENCE TO RELATED APPLICATION

This application claims the benefit of Korean Patent Application No. 10-2014-0038753, filed on Apr. 1, 2014, and No. 10-2014-0118963, filed on Sep. 5, 2014, in the Korean Intellectual Property Office, the disclosure of which is incorporated herein in its entirety by reference.

### BACKGROUND

The inventive concepts relate to a method of segmenting touch data, and more particularly, to a method of segmenting touch data of a touch panel by using a touch controller.

A user interface of a personal computer, a mobile communication device, and a privately-owned information processor, or the like is formed by using various input devices such as a keyboard, a mouse, and a digitizer. A touch panel that a user directly touches with a pen or fingers in order to input information has been used to meet the demand for input devices that are easy to carry and use. A method of segmenting touch data by detecting touched locations on the touch panel requires long operation times and a large number of operations to search for touch nodes, and thus, a considerable amount of a memory needs to be used.

### SUMMARY

The inventive concepts provide a method of segmenting touch data and a touch controller for performing the same in order to reduce memory consumption, operation times, and/or the number of operations.

According to an aspect of the inventive concepts, there is provided a method of segmenting touch data, the method including: selecting a peak node having a peak node value in touch data of a touch panel and assigning a label to the selected peak node; and performing segmentation of the touch data based on the selected peak node.

The performing of the segmentation based on the selected peak node may include: (a) setting the selected peak node as a first node and searching for a node having a lowest node value from among neighboring nodes of the first node; (b) setting the node having the lowest node value as a second node, selecting a node having a highest node value from among unlabeled neighboring nodes of the second node, and storing the selected node in a memory; and (c) setting the node having the highest node value as a third node, selecting a node having a highest node value from among unlabeled neighboring nodes of the third node that have node values greater than the node value of the third node, and storing the selected node in the memory.

(c) The setting of the node having the highest node value as the third node may include assigning a label, which is the same as a label of the peak node, to the nodes stored in the memory when there is no unlabeled neighboring node of the third node having a node value greater than the node value of the third node.

The method may further include performing (a) through (c) when there are valid neighboring nodes of the second node that are not labeled.

The method may further include determining a touch state of nodes of the touch data based on changes in energy in a vertical direction or a horizontal direction.

A node may be determined as being in the touch state when the energy in the vertical or horizontal directions increases and then decreases, the energy in the vertical or horizontal directions increases, or the energy in the vertical or horizontal directions decreases.

The method may further include tracking the selected peak node based on state information of peak nodes in a previous frame of the touch data; and determining a state of the selected peak node.

The tracking of the selected peak node may include: measuring a distance between the peak nodes in the previous frame and the selected peak node in a current frame; connecting a peak node in the previous frame to the selected peak node, wherein the previous frame is closest, from among previous frames, to the current frame; and setting the peak node based on state information about the peak node in the previous frame which is connected to the selected peak node.

The determining of the state of the selected peak node may include: by using a first threshold value and a second threshold value, classifying the state of the selected peak node into a no-touch state, a noise state, a touch state, or a pending state according to the peak node value; and setting the first threshold value as a reference for determining whether a touch occurs and setting the second threshold value as a reference for indicating that the touch panel is fully touched, wherein the second threshold value is greater than the first threshold value.

The pending state may be determined when the peak node, which is in the previous frame and is connected to the selected peak node, is in the touch state and the peak node value of the selected peak node is between the first threshold value and the second threshold value, and in the pending state, state determination of the peak node may be deferred to be performed in a next frame.

According to another aspect of the inventive concepts, there is provided a touch sensor system including: a touch panel; and a touch controller for receiving touch signals transmitted by the touch panel so as to generate touch data, selecting a peak node having a peak value in the touch data, and performing segmentation based on the peak node by assigning a label to the peak node.

The touch controller may be configured to determine a touch state of nodes of the touch data based on a change in energy in a horizontal direction or a vertical direction.

The touch state of the nodes may be determined when the energy in the vertical or horizontal direction increases and then decreases, when the energy in the vertical or horizontal direction increases, or when the energy in the vertical or horizontal direction decreases.

The touch controller may be configured to track the peak node based on state information of peak nodes in a previous frame of the touch data and to determine a state of the peak node.

The touch controller may be configured to: measure respective distance between the peak nodes in the previous frame and the selected peak node, wherein the selected peak node is in a current frame; connect one of the peak nodes in the previous frame to the selected peak node in the current frame, wherein the previous frame is closest, from among previous frames, to the current frame; and obtain the peak node based on state information about the peak node which is in the previous frame and connected to the selected peak node.

The touch controller may be configured to: set the peak node as a first node and search for a node having a lowest node value from among neighboring nodes of the first node; set the node having the lowest node value as a second node and select a node having a highest node value from among unlabeled neighboring nodes of the second node; set the node having the highest node value as a third node and select a node having a highest node value from among unlabeled neighboring nodes of the third node that have node values greater than the node value of the third node; and assign a label, which is the same as a label of the peak node, to the selected nodes when there is no unlabeled neighboring node of the third node that has a node value greater than the node value of the third node.

According to another aspect of the inventive concepts, there is provided a touch sensor system including: a touch panel; and a touch controller which generates touch data by receiving touch signals transmitted by the touch panel, selects a peak node having a peak value in the touch data, labels the selected peak node, searches for neighboring nodes based on the selected peak node, and stores touch data of the selected peak node in a memory based on a result of the searching.

The touch controller may be configured to: determine a first node having a smallest node value from among neighboring nodes of the selected peak node; determine a second node having a highest node value from among unlabeled valid neighboring nodes of the first node; and determine a third node having a highest node value from among unlabeled valid neighboring nodes of the second node.

The memory may store touch data of the second and third nodes.

The touch controller may assign a label, which is the same as a label of the selected peak node, to the second and third nodes stored in the memory when there is no unlabeled neighboring node of the third node which has a node value greater than the node value of the third node.

According to another aspect of the inventive concepts, there is provided a method of segmenting touch data including: selecting a first peak node in the touch data of a touch panel; assigning a first label to the first peak node; searching a first region including the labeled first peak node and at least one unlabeled neighboring node of the first peak node; and labeling the at least one unlabeled node in the first region according to the first label.

The first region may include a matrix including the first peak node and the at least one unlabeled neighboring nodes of the first peak node.

The labeling the at least one unlabeled neighboring node may include selecting an unlabeled node in the first region as a current center node, storing node information of the current center node in a memory, selecting a labeled highest neighboring node of the current center node, and assigning the first label to the selected unlabeled node based on the node information stored in the memory.

The labeling the at least one unlabeled neighboring node may further include invalidating the unlabeled node corresponding to the node information stored in the memory when a memory overflow occurs after storing node information, and emptying the node information from the memory.

The selecting an unlabeled node in the first region may include selecting an unlabeled neighboring node of the peak node, and assigning the selected unlabeled lowest node to the current center node.

The selecting an unlabeled node in the first region may include selecting an unlabeled highest neighboring node of the current center node, and assigning the selected unlabeled highest node to the current center node.

The method of segmenting touch data may further include emptying node information stored in the memory after labeling the node.

The method of segmenting touch data may further include completing labeling the first region, and changing the size of the first region or moving the first region to include at least one the labeled nodes and at least one of the unlabeled nodes in the touch data.

The method of segmenting touch data may further include selecting a second peak node in the touch data, assigning a second label to the second peak node, searching a second region including the labeled second peak node and at least one of unlabeled neighboring nodes of the second peak node, and labeling the at least one unlabeled neighboring nodes based on the second label.

The method of segmenting touch data may further include tracking the first peak node based on state information of one or more peak nodes in a previous frame of the touch data, and determining a state of the first peak node.

The tracking of the first peak node may include measuring a distance between the one or more peak nodes in the previous frame and the first peak node in a current frame, selecting a peak node of the one or more peak nodes in the previous frame based on the measured distance, and setting the state of the first peak node based on state of the selected peak node in the previous frame.

The determining a state of the first peak node may include comparing a node value of the peak node with a first threshold value and a second threshold value based on the state of the selected peak node, and classifying the state of the first peak node into a no-touch state, a noise state, a touch state, or a pending state based on a node value of the first peak node, wherein the first threshold value indicates whether a touch occurs and the second threshold value indicates whether the touch panel is fully touched.

The pending state indicates that the selected peak node in the previous frame is in touch state and the state of the first peak node is greater than the first threshold value and is equal to or less than the second threshold, and in the pending state, determination of the state of the first peak node is deferred to be performed in a next frame.

The method of segmenting touch data may further include determining a touch state of the touch panel based on changes in energy in a vertical direction or a horizontal direction.

The touch panel is determined as being in the touch state when the energy in the vertical or horizontal directions increases and then decreases, the energy in the vertical or horizontal directions increases, or the energy in the vertical or horizontal directions decreases.

According to another aspect of the inventive concepts, there is provided a touch sensor system including a touch panel; and a touch controller configured to receive touch signals from the touch panel, generate touch data, label a peak node having a peak value in the touch data, and perform segmenting the touch data based on the labeled peak node by searching at least one unlabeled neighboring node of the labeled peak node as a current center node in a first region including the first peak node and the at least one of unlabeled neighboring node, storing node information of the current center node in a memory, and labeling the at least one unlabeled neighboring node based on the node information.

The first region comprises a matrix including the first peak node on a center of the matrix and the at least one unlabeled neighboring node of the first peak node.

The touch controller is configured to select one of the unlabeled neighboring nodes of the first peak node as a current center node, store node information of the current center node in a memory, select a labeled node having the highest neighboring node of the current center node, and label a node corresponding to the node information stored in the memory according to the first label.

The selected one of the unlabeled nodes is a node having the lowest node value neighboring the first peak node.

The selected one of the unlabeled nodes is a node having the highest node value neighboring the current center node.

According to another aspect of the inventive concepts, there is provided a method of segmenting touch data including: selecting a first peak node as a first center node in the touch data of a touch panel; assigning a first label to the first peak node; defining a first region including the first peak node and an unlabeled neighboring node of the first peak node; labeling the first region according to the first label; and extending the first region to include one or more unlabeled node in the touch data.

The first region may include a matrix including the first peak node on a center in the matrix and the unlabeled neighboring node of the first peak node.

The labeling the region may include selecting an unlabeled node in the first region as a current center node, storing node information of the current center node in a memory, selecting a labeled node having the highest node value neighboring the current center node, and assigning the first label to the unlabeled node based on the node information stored in the memory.

The labeling the unlabeled neighboring node may further include selecting an unlabeled node having the highest node value neighboring the current center node, storing node information of the selected unlabeled node having the highest node value, and updating the current center node with the selected unlabeled node having the highest node value.

The method of segmenting touch data may further include emptying node information stored in the memory after assigning the first label to the unlabeled node.

### BRIEF DESCRIPTION OF THE DRAWINGS

Example embodiments of the inventive concepts will be more clearly understood from the following detailed description taken in conjunction with the accompanying drawings in which:

FIG. 1 is a structural block diagram of a touch controller;

FIGS. 2A through 2C are diagrams of a touch panel of FIG. 1;

FIG. 3 is a flow chart of a method of segmenting touch data, according to one or more embodiments of the inventive concepts;

FIGS. 4 through 5C are diagrams of a method of determining touch states, according to one or more embodiments of the inventive concepts;

FIGS. 6A and 6B are diagrams of a method of determining peak nodes of touch data, according to one or more embodiments of the inventive concepts;

FIG. 7 is a diagram of a method of tracking peak nodes of touch data, according to one or more embodiments of the inventive concepts;

FIGS. 8 and 9 are diagrams of a method of determining states of peak nodes of touch data, according to one or more embodiments of the inventive concepts;

FIGS. 10A through 10G are diagrams of a method of segmenting touch data, according to one or more embodiments of the inventive concepts;

FIG. 11 is a view of a touch display device having a touch controller, according to one or more embodiments of the inventive concepts; and

FIG. 12 illustrates a variety of products in which a touch sensor system including a touch controller is installed, according to one or more embodiments of the inventive concepts.

### DETAILED DESCRIPTION OF THE EMBODIMENTS

The attached drawings for illustrating preferred embodiments of the present invention are referred to in order to gain a sufficient understanding of the present invention, the merits thereof, and the objectives accomplished by the implementation of the present invention.

The present invention will now be described more fully with reference to the accompanying drawings, in which example embodiments of the invention are shown. The invention may, however, be embodied in many different forms and should not be construed as being limited to the embodiments set forth herein; rather, these embodiments are provided so that this disclosure will be thorough and complete, and will fully convey the concepts of the invention to those skilled in the art. However, this is not intended to limit the present invention to particular modes of practice, and it is to be appreciated that all changes, equivalents, and substitutes that do not depart from the spirit and technical scope of the present invention are encompassed in the present invention. Like reference numerals in the drawings denote like elements. Sizes of components in the drawings may be exaggerated for convenience of explanation.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Recently, electronic devices have become so small and slim that a touch screen is widely used instead of a button-type interface, for example, a keyboard. According to operating principles, a touch screen may be a resistive-type touch screen, a surface acoustic wave type touch screen, an infrared-beam type touch screen, an electrostatic capacitive type touch screen, etc.

The electrostatic capacitive type touch screen detects a change in capacitance in a circuit including a touch sensor and then calculates touch coordinates by reading the detected change in capacitance in the circuit and outputting the touch coordinates directly or data with regard to the touch coordinates. The electrostatic capacitive type touch screen recognizes the occurrence of touches by detecting a change in capacitance between two electrodes. In order to recognize the occurrence of the touches, two-dimensional (2D) touch data is segmented (hereinafter, referred to as ‘segmentation’).

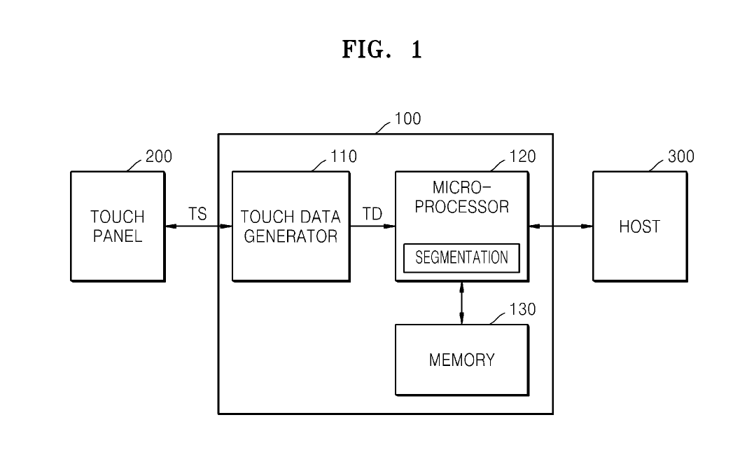

FIG. 1 is a structural block diagram of a touch controller 100 performing a method of segmenting touch data, according to one or more embodiments.

Referring to FIG. 1, the touch controller 100 is connected between a touch panel 200 and a host 300. The touch controller 100 recognizes the occurrence of touches on the touch panel 200, calculates coordinates of touched locations, and transmits the calculated coordinates to the host 300. When a touch occurs, the touch panel 200 transmits a change in physical properties of the touched locations to the touch controller 100. In a case where the touch panel 200 is an electrostatic capacitive type touch panel, the touch panel 200 transmits touch signals TS, which indicate a change in mutual capacitance between the touched location, to the touch controller 100.

The touch controller 100 includes a touch data generator 110, a microprocessor 120, and a memory 130. The touch data generator 110 receives the touch signals TS transmitted by the touch panel 200 and generates touch data TD. The touch signals TS may be analog signals that are output as measurement values of the mutual capacitance that changes due to touching the touch panel 200. The touch data generator 110 may perform a process for amplifying and converting the touch signals TS and generate the touch data TD that is a digital signal. (Touch signals TS->Touch signal TS)

The microprocessor 120 receives the touch data TD generated by the touch data generator 110 and determines whether valid touches or multi-touches occur by examining the touch data TD. The microprocessor 120 calculates valid touch coordinates and transmits the calculated valid touch coordinates to the host 300. When the multi-touches occur, the microprocessor 120 may calculate multi-touch coordinates. The microprocessor 120 may label the touch data TD and segment the labeled touch data TD into label groups by using a multi-touch algorithm. A label group is an identifier used to determine to which group the touch data TD belong among groups segmented as multi-touch groups.

The microprocessor 120 may perform the method of segmenting the touch data TD. The method includes performing segmentation based on peak nodes of the touch data TD and labeling neighboring nodes. The method includes determining whether nodes are in a touch state by using the touch data TD. When nodes are in a touch state, every node of the touch data TD is searched, and a peak node having a peak value is selected. When the peak node is determined, state information of the peak node is tracked based on state information of a peak node in a previous frame. After the state information of the peak node is tracked, the state of the peak node is determined. Then, the segmentation of the touch data TD is performed.

The memory 130 may store the multi-touch algorithm executed by the microprocessor 120 or a program that performs the method of segmenting the touch data TD. The memory 130 may store data (or information about center nodes) that is generated while the multi-touch algorithm or the method of segmenting the touch data TD is performed. The information about the center nodes, which is stored in the memory 130, may be used by the microprocessor 120 to calculate the touch coordinates.

The host 300 may be an application processor of a touch sensor system including the touch panel 200 and the touch controller 100. The touch sensor system may be included in a personal computer, a mobile communication system, a personal information processing system, etc.

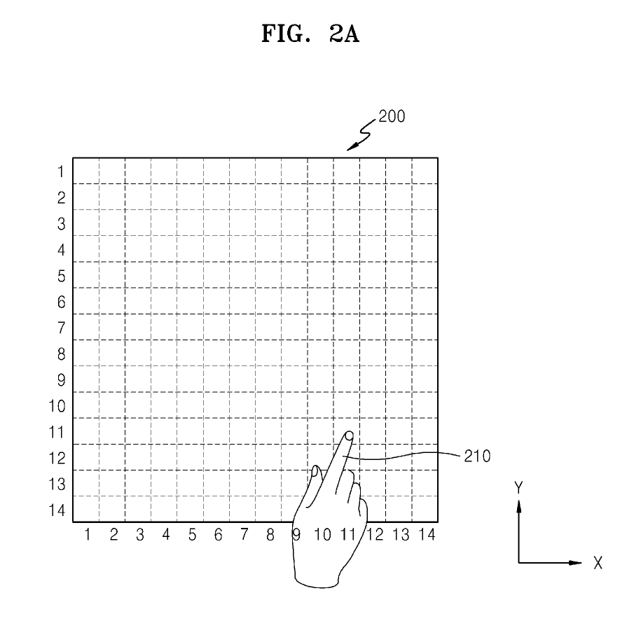

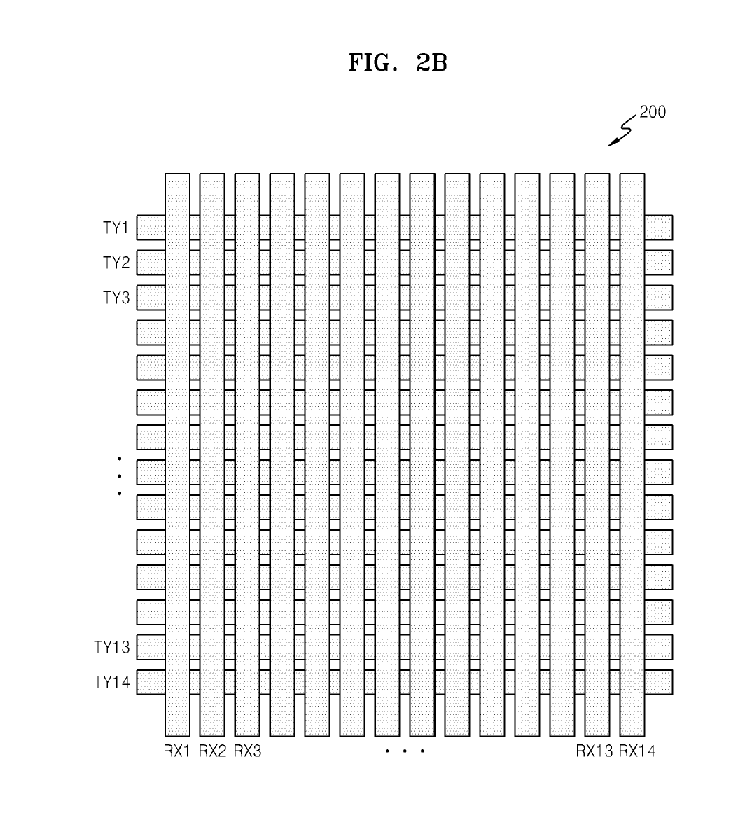

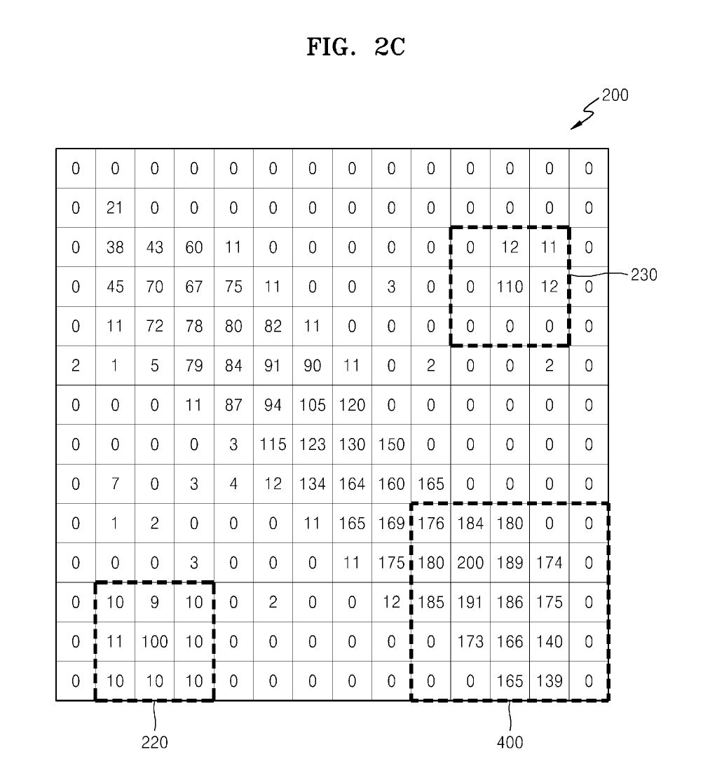

FIGS. 2A through 2C are diagrams of the touch panel 200 of FIG. 1.

Referring to FIG. 2A, a finger 210 touches the touch panel 200. The finger 210 functions as a coordinate indicator. According to example embodiments, a stylus pen may be used instead of the finger 210. In the example embodiment of the present inventive concepts, the finger 210 touches an 11^{th} node in an X direction and an 11^{th} node in a Y direction.

Referring to FIG. 2B, the touch panel 200 may be a touch panel using a mutual capacitance sensing method. The touch panel 200 includes driving electrodes TY1 through TY14 and sensing electrodes RX1 through RX14. In the example embodiment of the present inventive concepts, a case where fourteen driving electrodes TY1 through TY14 and fourteen sensing electrodes RX1 through RX14 are included in the touch panel 200 will be explained. According to embodiments, the number of driving electrodes and sensing electrodes included in the touch panel 200 may vary. In addition, shapes of the driving electrodes and the sensing electrodes may vary according to embodiments.

The driving electrodes TY1 through TY14 are arranged in a horizontal direction and the sensing electrodes RX1 through RX14 are arranged in a vertical direction in the touch panel 200. The driving electrodes TY1 through TY14 and the sensing electrodes RX1 through RX14 are alternately arranged. Mutual capacitance is generated between the driving electrodes TY1 through TY14 and the sensing electrodes RX1 through RX14 that are alternately arranged. A location where the mutual capacitance is generated between the driving electrodes TY1 through TY14 and the sensing electrodes RX1 through RX14 may be defined as a node.

Nodes on the touch panel 200 may be arranged in a matrix form as illustrated in FIG. 2C. Each node may be identified, depending on a combination of a row number and a column number. For example, a node arranged at a 4^{th} row and a 3^{rd} column may be indicated as a node (4, 3) on the touch panel 200. Each node may have one or more neighboring nodes. For example, eight neighboring nodes may be arranged around one node.

In the touch panel 200, capacitance of a node where the driving electrodes TY1 through TY14 and the sensing electrodes RX1 through RX14 are alternately arranged may be measured by applying constant voltage pulses to the driving electrodes TY1 through TY14 and collecting charges corresponding to the voltage pulses from the sensing electrodes RX1 through RX14. When a conductive object such as a finger of a user or a stylus pen approaches the nodes of the touch panel 200, an electric field is generated, and thus, the capacitance may be decreased. As illustrated in FIG. 2C, touch data TD of each node may be obtained by measuring the decrease in capacitance. For example, touch data TD of a node (2, 2) is 21, and that of a node (11, 11) is 200. The touch panel 200 may have a plurality of touch regions 220, 230 and 400.

The inventive concepts describes a method of segmenting touch data TD, the method including: identifying touched areas before segmentation of the touch data TD is performed; extracting information about the touched areas; and performing the segmentation of the touch data TD. The inventive concepts may be implemented via a program that performs the method of segmenting the touch data TD by using the touch controller 100 of FIG. 1 or firmware (F/W) on which the above-described program is recorded.

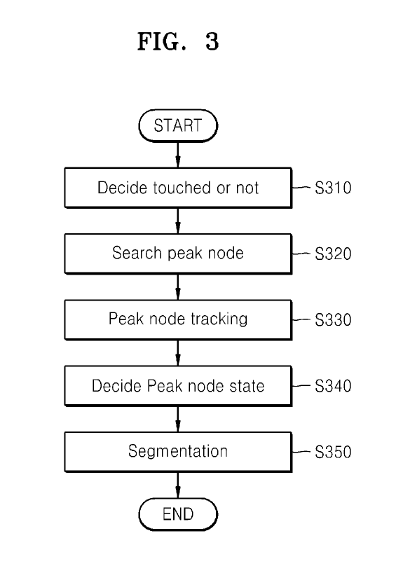

FIG. 3 is a flow chart of the method of segmenting the touch data TD, according to one or more embodiments of the inventive concepts.

Whether nodes of the touch data TD are in a touch state is determined first in step S310. The touch data TD is generated by the touch data generator 120 of FIG. 1 that receives touch signals TS of each node on the touch panel 200 of FIG. 1. When touches occur in the touch panel 200, a change in the mutual capacitance becomes large. Thus, the touch signals TS and the touch data TD may have large node values. When touches do not occur in the touch panel 200, the mutual capacitance does not change, and thus, the touch signals TS and the touch data TD may have substantially small node values. Although no touches occur in the touch panel 200, the mutual capacitance may change due to noises. In this case, the change in the mutual capacitance is little, and thus, the touch signals TS and the touch data TD may have small node values. When the node values of the touch data TD are smaller than a first threshold value, the touch data TD may be determined as noise.

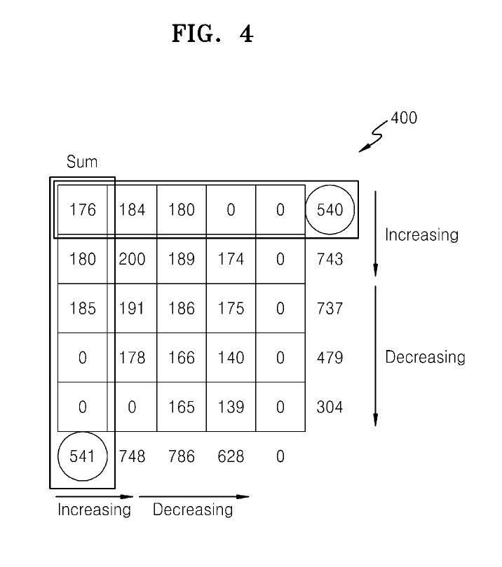

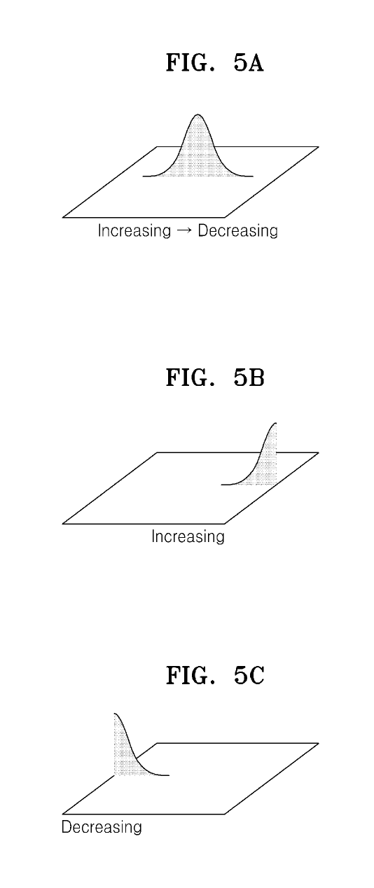

Energy in a horizontal direction and that in a vertical direction may be calculated in a frame of the touch data TD. The energy in the horizontal direction means a total sum of touch data TD corresponding to nodes arranged in the horizontal direction, and the energy in the vertical direction means a total sum of touch data TD corresponding to nodes arranged in the vertical direction. The touch state of the nodes may be determined by detecting a change in the energy in the horizontal and vertical directions of the touch data TD. That is, whether a touch event happens or not may be determined based on the change in the energy in the horizontal and vertical directions, which will be described in detail with reference to FIGS. 4 through 5C.

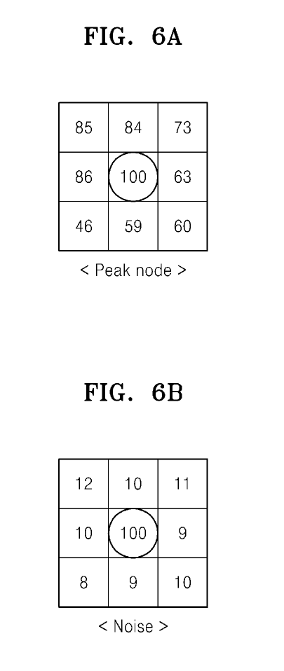

A node of the touch data TD having a peak value is selected by searching for every node of the touch data TD in step S320. The touch data TD of each node may be a node value of the node. When a node value of the selected node is greater than node values of neighboring nodes, the selected node may be set as a peak node. A location and a node value of the peak node may be stored in the memory 130 of FIG. 1. Although the node value of the selected node is greater than the node values of the neighboring nodes, the node value of the selected node is determined as being noise if the node values of the neighboring nodes are smaller than valid node values (for example, the first threshold value). The method of searching a peak node will be described in detail with reference to FIGS. 6A and 6B.

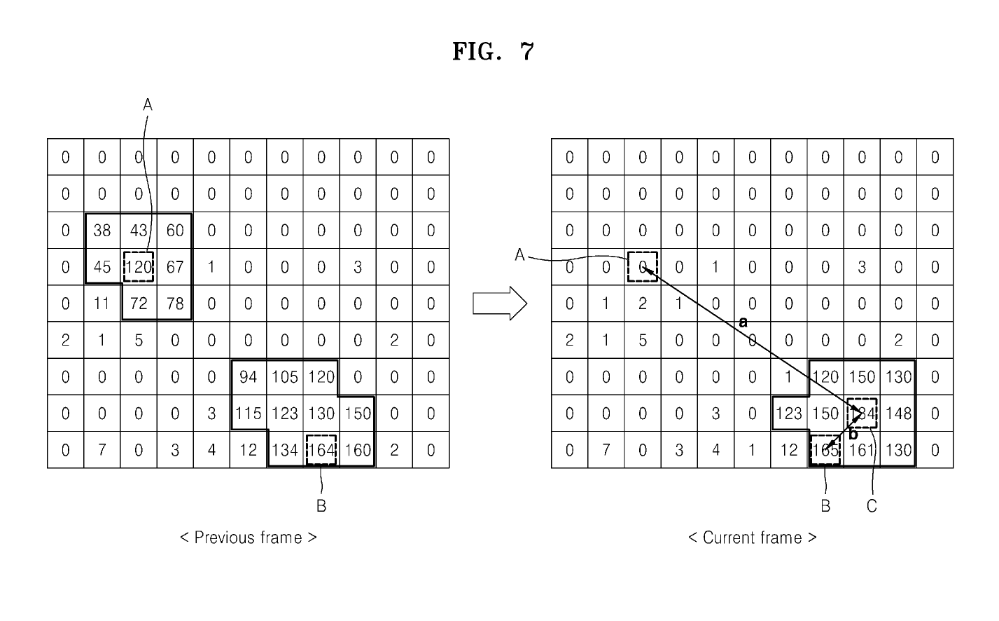

A peak node of the previous frame related to the peak node of the current frame can be tracked in step S330. Distances between locations of the peak nodes in the previous frames and locations of peak nodes in the current frame may be measured to track the peak nodes of the previous frame related to the peak node of the current frame. That is, one of the peak nodes in the current frame is connected to one of the peak nodes in the previous frame that is the closest in distance. Based on the distance between the peak nodes of the previous frame and the current frame, a peak node of the previous frame related to a peak node of the current frame can be tracked. The method of tracking a corresponding peak node of the previous frame will be described in detail in FIG. 7.

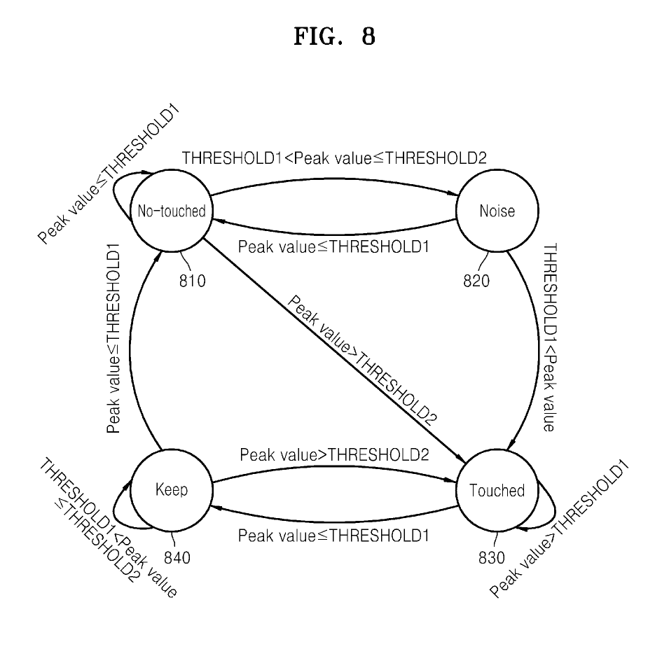

A state of the peak node is determined in step S340. The state of the peak node included in the touch data TD may be determined based on a state of the peak node of the previous frame and a node value of the peak node of the current frame. The state of peak nodes may be one of NO_TOUCH state, NOISE state, TOUCH state, or PENDING state. The method of determining of the state of the peak node of the current frame will be described in detail in FIG. 8. A position, a node value and a state of a node of the current frame may be provided as parameters for segmenting the touch data TD.

The segmentation of the touch data TD is performed in step S350. The method of segmenting the touch data TD includes labeling a peak node based on the state of the peak node, and searching a node having the lowest node value among valid neighboring nodes of a first center node which is the peak node. The node having the lowest node value is set as a second center node. A node information of the second center node may be stored in the memory 130 of FIG. 1. A node information of a node may include a position coordinate and a node value of the node.

A node having a highest node value among unlabeled valid neighboring nodes of the second center node is selected as a third center node. A node information of the third center node may be stored in the memory 130 of FIG. 1. A node which has a highest node value among unlabeled neighboring nodes of the third center node and has higher node value than the node value of the third center node, is selected as a next center node. A node information of the next center node may be stored in the memory 130 of FIG. 1.

The process may be iterated that a node is selected as a next center node when the node belongs to unlabeled neighboring nodes of the previous center node and has the highest node values among the unlabeled neighboring nodes until there is no more unlabeled node having higher node value than the node value of the previous center node. As a result, the stacked center nodes in the memory 130 may have the same label as the label assigned to the peak node.

According to the example embodiment of the present inventive concepts, segmenting touch data may be performed effectively with a small size memory to segment the touch data by iterating searching neighboring nodes of a peak node, storing selected nodes' node information in a memory and labeling the neighboring nodes based on the stored node information.

In the example embodiment of the present inventive concepts, since the neighboring nodes are labeled after the segmentation is performed based on the peak nodes of the touch data TD, the number of node information stored in the memory 130 may be reduced. Accordingly, memory consumption required for the segmentation of the touch data TD may be reduced.

FIGS. 4 through 5C are diagrams of a method of determining touch states, according to one or more embodiments of the inventive concepts.

FIG. 4 illustrates touch data TD of each node included in a part 400 of the touch panel 200 of FIG. 2C. The total sum of the touch data TD in the horizontal direction is 540 in a first row, 743 in a second row, 737 in a third row, 479 in a fourth row, and 304 in a fifth row. The total sum of the touch data TD in the horizontal direction is equal to the energy in the horizontal direction. In other words, the energy in the horizontal direction is respectively 540, 743, 737, 479, and 304 for the first through fifth rows. The energy increases from 540 to 743, but then decreases to 737, 479 and then 304. The total sum of the touch data TD in the vertical direction is 541 in a first column, 748 in a second column, 786 in a third column, 628 in a fourth column, and 0 in a fifth column. The total sum of the touch data TD in the vertical direction is equal to the energy in the vertical direction. In other words, the energy in the vertical direction is respectively 541, 748, 786, 628, and 0 for the first through fifth columns. The energy in the vertical direction increases from 541 to 748, and then to 786, but then decreases to 628 and then 0.

Referring to FIG. 4, changes in the energy in the horizontal and vertical directions increase and then decrease. Accordingly, the touch data TD of FIG. 4 is determined as being in the touch state. That is, when the change in the energy in the touch data TD increases and then decreases as illustrated in FIG. 5A, the touch data TD is determined as being in the touch state. According to embodiments, the change in the energy in the touch data TD increases, the touch data TD may be determined as being in the touch state, as illustrated in FIG. 5B. According to embodiments, the change in the energy in the touch data TD decreases, the touch data TD may be determined as being in the touch state, as illustrated in FIG. 5C.

FIGS. 6A and 6B are diagrams of a method of determining valid peak nodes of the touch data TD, according to one or more embodiments of the inventive concepts.

FIG. 6A illustrates touch data TD of each node of a first part on the touch panel 200 of FIG. 1. A node of the touch data TD having a peak value of 100 is selected. Node values of neighboring nodes around the node having the node value of 100 are equal to or greater than the first threshold value, for example, 15. Since the neighboring nodes have a node value of at least 15, the neighboring nodes are thus determined as being valid nodes. Therefore, the node having the peak value of 100 is determined as being a peak node.

FIG. 6B illustrates touch data TD of each node of a second part on the touch panel 200 of FIG. 1. A node of the touch data TD having a peak value of 100 is selected. Node values of neighboring nodes around the node having the node value of 100 are less than a first threshold value, for example, 15. Since all the neighboring nodes have a node value less than 15, all the neighboring nodes are thus determined as being invalid nodes. Therefore, the node having the peak value of 100 is determined as being a peak node. For example, in the touch data TD of FIG. 2C, a peak node having a peak value of 100 of a first touch region 220 (i.e., node (3,13) having touch data TD of 100) and a peak node having a peak value of 110 of a second touch region 230 (i.e., node (12,4) having touch data TD of 110) have invalid neighboring nodes, and thus, the invalid neighboring nodes are determined as noise components.

FIG. 7 is a diagram of a method of tracking peak nodes of touch data TD, according to one or more embodiments of the inventive concepts.

FIG. 7 illustrates touch data TD of a previous frame and that of a current frame in a third part on the touch panel 200 of FIG. 1. Peak nodes of the previous frame are A and B, and a peak node of the current frame is C. A distance a between the peak node A of the previous frame and the peak node C of the current frame and a distance b between the peak node B of the previous frame and the peak node C of the current frame are measured. Since the distance b has a smaller value than the distance a, the peak node B of the previous frame and the peak node C of the current frame are connected. The peak node C of the current frame enters a state based on state information of the peak node B of the previous frame. The state information of the peak node B of the previous frame includes information of a noise state, a touch state, or a pending state. When the peak node C is included in multi-touch data, the state information may include labeling information.

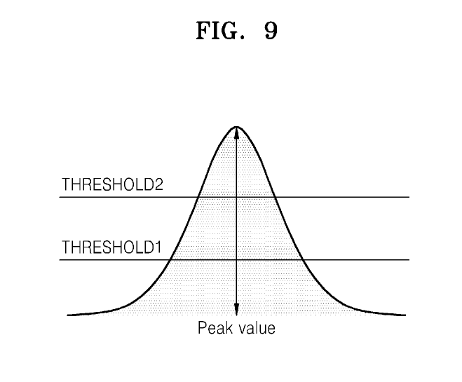

FIGS. 8 and 9 are diagrams of a method of determining a state of a peak node of the touch data TD.

Referring to FIGS. 8 and 9, a state of the peak node is determined by using a peak node value. The state of the peak node may be classified into a no-touch state 810, a touch state 830, or a pending state 840 according to a state of the peak node in a previous frame and the peak node value. The state of the peak node may be determined by using the first threshold value THRESHOLD1 and the second threshold value THRESHODL2 as illustrated in FIG. 9. The first threshold value THRESHOLD1 is used as a reference to determine whether a touch equal to or greater than noise occurs. The second threshold value THRESHOLD2 is greater than the first threshold value THRESHOLD1 and is used as a reference indicating that the touch panel 200 is touched valid.

The no-touch state 810 is a state in which the peak node value is less than or equal to the first threshold value. When the peak node, which has been in the no-touch state 810 in the previous frame, has a node value that is less than or equal to the first threshold value in the current frame, the peak node in the current frame is determined as being in the no-touch state 810. When the peak node, which has been in the no-touch state 810 in the previous frame, has a node value in the current frame that is greater than the first threshold value but is less than or equal to the second threshold value, the peak node in the current frame is determined as being in the noise state 820. When the peak node, which has been in the no-touch state 810 in the previous frame, has a node value in the current frame that is greater than the second threshold value, the peak node in the current frame is determined as being in the touch state 830.

The noise state 820 is a state in which the peak node value is greater than the first threshold value but is less than or equal to the second threshold value. When the peak node, which has been in the no-touch state 810 in the previous frame, has a node value in the current frame that is greater than the first threshold value but is less than or equal to the second threshold value, the peak node in the current frame is determined as being in the noise state 820. When the peak node, which has been in the noise state 820 in the previous frame, has a node value in the current frame that is equal to or less than the first threshold value, the peak node in the current frame is determined as being in the no-touch state 810. When the peak node, which has been in the noise state 820 in the previous frame, has a node value in the current frame that is greater than the first threshold value, the peak node in the current frame is determined as being in the touch state 830.

The touch state 830 is a state in which the peak node value is greater than the first threshold value than the first threshold value. When the peak node, which has been in the touch state 830 in the previous frame, has a node value in the current frame that is less than or equal to the first threshold value, the peak node in the current frame is determined as being in the pending state 840.

The pending state 840 is a state in which state determination of the peak node is deferred to be performed in a next frame, and in which the peak node value is greater than the first threshold value but is equal to or less than the second threshold value. When the peak node, which has been in the pending state 840 in the previous frame, has a node value that is greater than the second threshold value, the peak node in the current frame is determined as being in the touch state 830. When the peak node, which has been in the pending state 840 in the previous frame, has a node value that is less than or equal to the first threshold value, the peak node in the current frame is determined as being in the no-touch state 810.

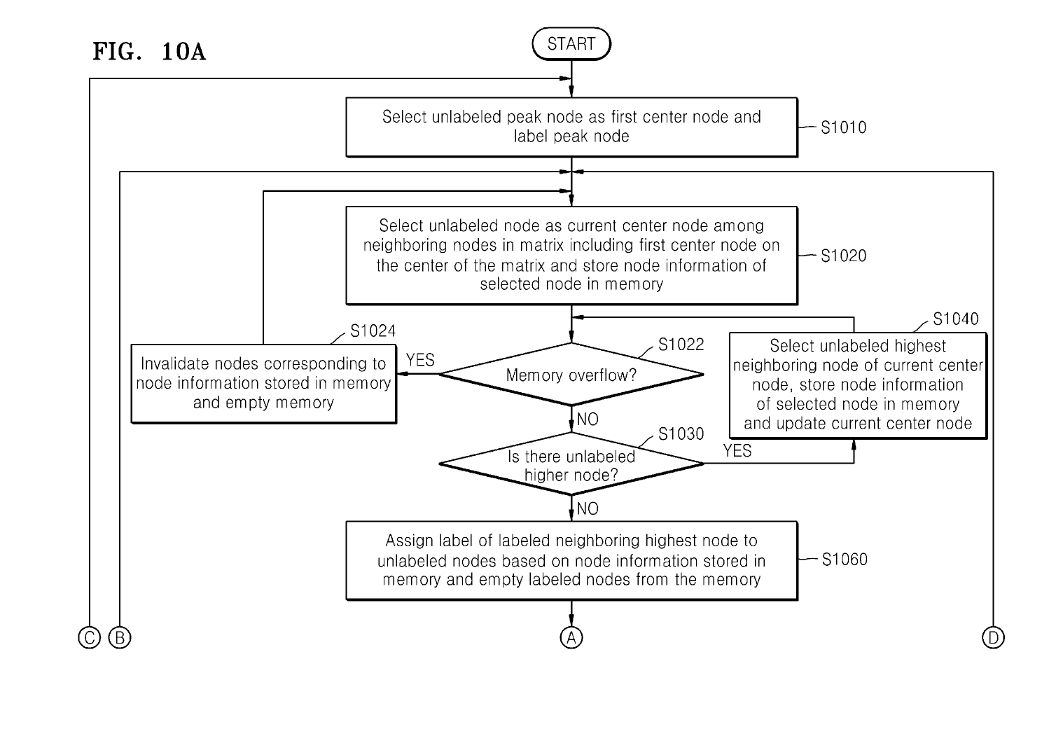

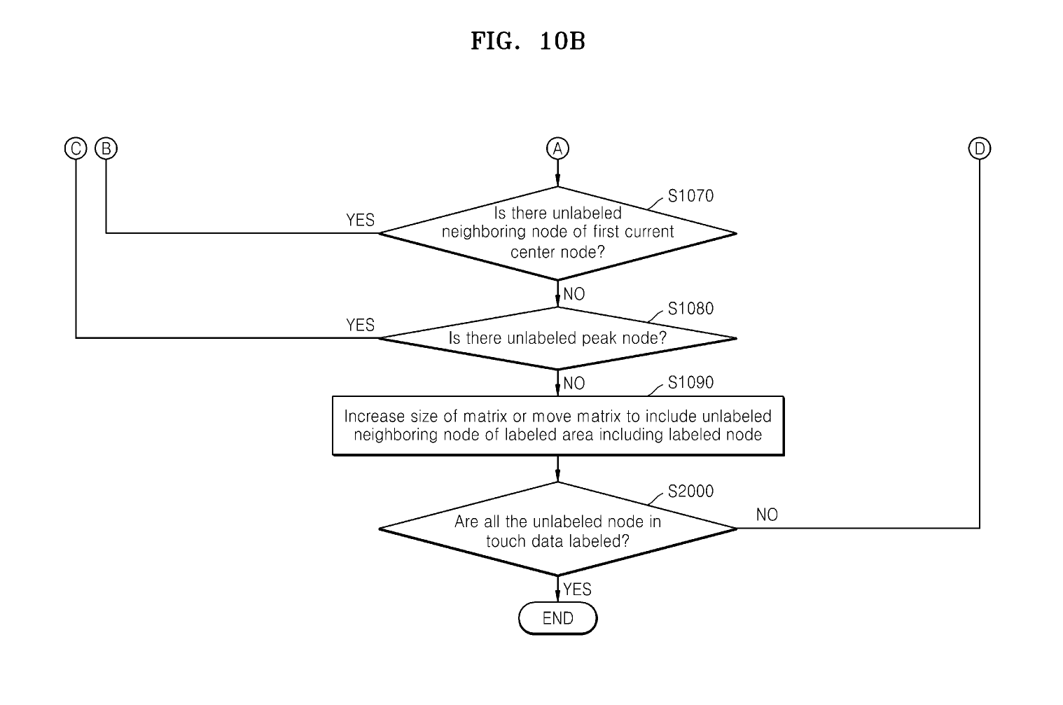

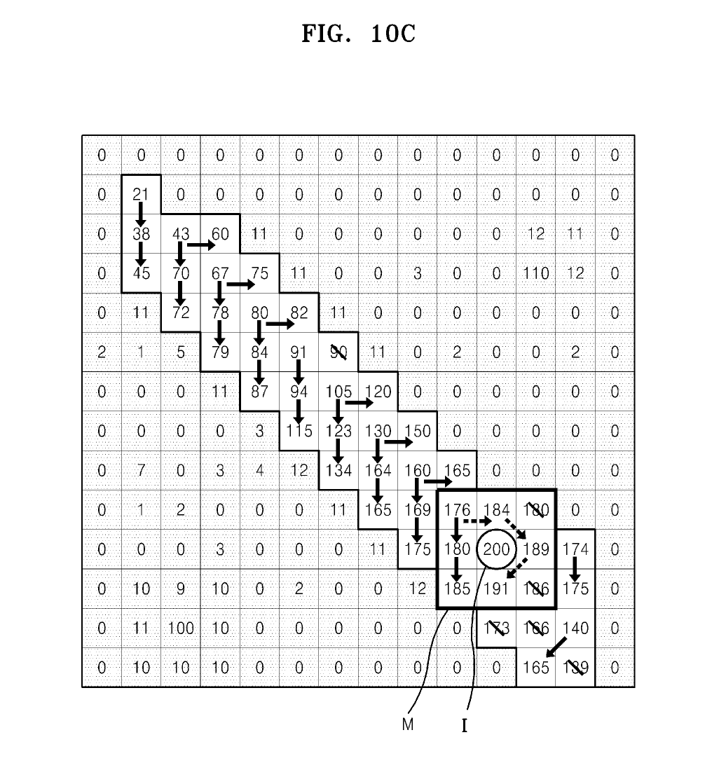

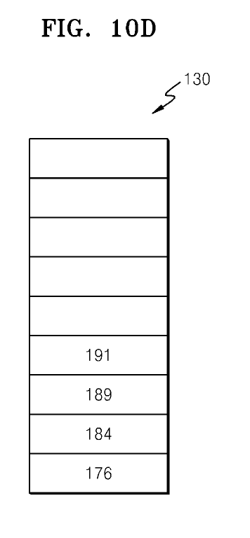

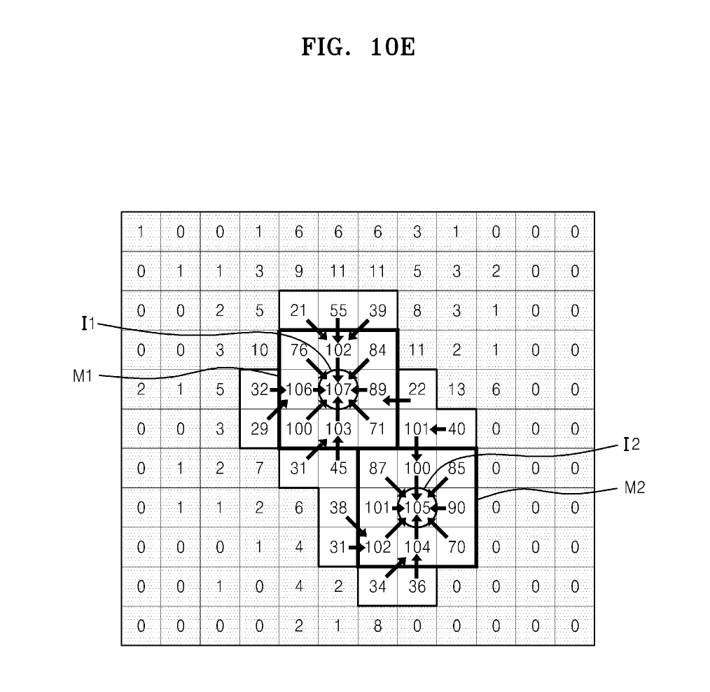

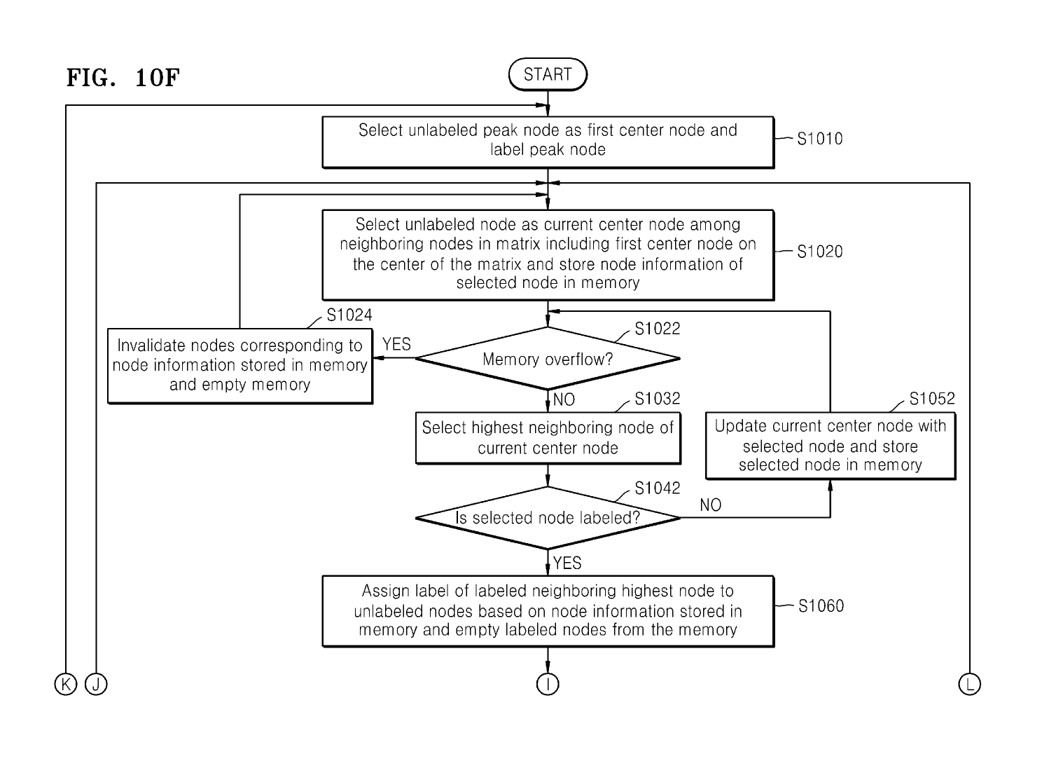

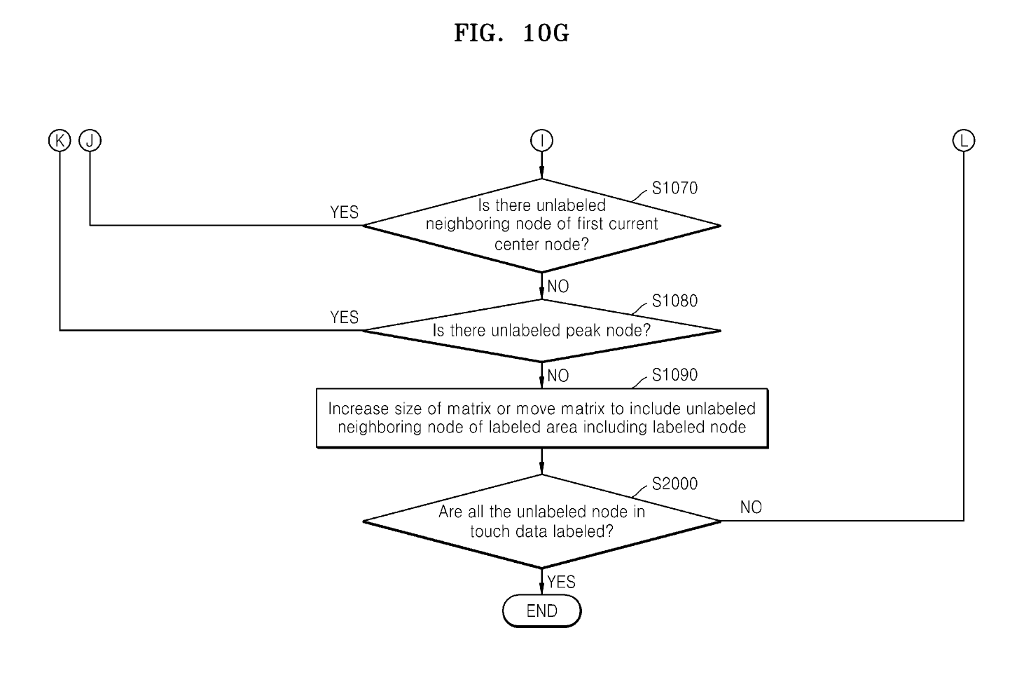

FIGS. 10A through 10G are diagrams of a method of segmenting the touch data TD, according to one or more embodiments of the inventive concepts.

In the example embodiments of the present inventive concepts, the highest node means a node having the highest node value and the lowest node means a node having the lowest node value. A higher node means a node having a higher node value and a lower node means a node having a lower node value. A peak node means a node having a peak node value. In addition, unless a node is defined as an invalid node, the node may be a valid node. A neighboring node may be a node having one or more node distance from a node and may be a node within a predefined distance from a current center node.

A flow chart of the method of segmenting the touch data TD of FIGS. 10A and 10B will be described by referring to frame touch data illustrated in FIGS. 10C and 10E and a memory 130 of FIG. 10D. FIG. 10C illustrates the same frame touch data as in FIG. 2C. FIG. 10E illustrates touch data having more than one valid peak node. Arrows in FIGS. 10C and 10E illustrates a path to select a neighboring node of a current center node.

Referring to FIGS. 10A to 10E, an unlabeled peak node of the frame touch data TD may be selected as a first center node and the first center node may be labeled in step S1010. For example, the peak node is a peak node I having a peak node value of 200 in FIG. 10C, or one of a peak node I1 and a peak node I2 having a peak node value of 107 and 105 respectively in FIG. 10E. A label is assigned to the peak node I. The first center node may be a center of a matrix which is used for searching neighboring nodes. For example, the node having a node value of 200 may be defined as a first center node and a 3 by 3 (3×3) matrix M including the first center node as a center of the matrix may be defined as illustrated in FIG. 10C. A plurality of matrixes M1 and M2 having a peak node value of 107 and 105 respectively may be defined as illustrated in FIG. 10E.

An unlabeled neighboring node of the first center node in the matrix may be selected as a current center node and a node information of the current center node may be stored in the memory 130 in step S1020. The current center node may be a node such as, but not limited thereto, a unlabeled node having the lowest node value in the matrix, a successively selected unlabeled node in the clockwise or counter clockwise direction from the left-top node of the matrix, and an unlabeled node selected by a predetermined order. For example, neighboring nodes included in the 3×3 matrix are searched for based on the peak node I in FIG. 10C. Eight neighboring nodes around the peak node I have node values of 176, 184, 180, 189, 186, 191, 185, and 180, respectively. The neighboring nodes are valid nodes having node values equal to or greater than the first threshold value, for example, 15. The neighboring node having the node value of 176, which is the lowest node value, may be selected as a current center node, but not limited thereto. A node information of the center node may be stored in the memory 130 of FIG. 10D. A node information of a node may include a position coordinate and a node value of the node.

Whenever a node information is stored in the memory 130, whether a memory overflow occurs may be determined in step S1022. If a memory overflow occurs in the memory 130 while performing steps S1020 and S1040, nodes corresponding to the node information stored in the memory 130 may be invalidated and the node information stored in the memory 130 may be emptied in step S1024. If there is no memory overflow, step S1030 may be performed. For example, if a search path goes farther away from the first center node due to noise in the touch data while searching a current center node, a memory overflow may occur because of storing a lot of current nodes on the search path. In this case, the nodes corresponding to node information stored in the memory 130 may be invalidated by deciding the abnormally long search path is invalid.

A determination whether an unlabeled neighboring node of the current center node exists which has a higher node value than the node value of the current center node in step S1030. If an unlabeled higher neighboring node of the current center node than the current center node exists, the unlabeled higher node may be selected and stored in the memory 130.

The selected node may be updated to the current center node in step S1040. If all the higher neighboring nodes of the current center node are labeled, step S1060 is performed. For example, when the current center node is a node having the node value of 176, eight neighboring nodes of the current center node may have node values of 160, 165, 0, 184, 200, 180, 175, and 169 in FIG. 10C. The neighboring node having the node value of 200 is labeled, and the neighboring nodes having node values of 160, 165, 0, 184, 180, 175, and 169 are unlabeled. The unlabeled neighboring node having the node value of 184, which is the highest node value among the unlabeled neighboring nodes, may be selected as the current center node. A node information about the unlabeled neighboring node as the current center node having the node value of 184 may be stored in the memory 130 of FIG. 10D. The steps S1030 and S1040 may be performed until there is no more higher neighboring node of the current center node. As a result, the node information corresponding to the node values in the order of 176-184-189-191 may be stored in the memory 130 and step S1060 may be performed.

The unlabeled nodes corresponding to the node information stored in the memory 130 may be labeled with the same label of the labeled neighboring highest node in step S1060, because there is no more unlabeled higher nodes than the current center node. As a result, a portion of the touch data TD is labeled. For example, in case of the current center node having a node value of 191 in FIG. 10C, there is no more unlabeled higher node than the current center node, the nodes having the node values of 191, 189, 184, and 176 may be labeled with the same label as the labeled highest node, the peak node I, having the node value of 200 and the stored node information corresponding to the nodes having the node values of 191, 189, 184, and 176 in the memory 130 may be emptied.

Whether an unlabeled neighboring node of the first center node exists is determined in step S1070. If an unlabeled neighboring node of the first center node exists, the method of segmentation may perform step S1020 to select as the current center node an unlabeled node among the unlabeled neighboring nodes of the first center node. If an unlabeled neighboring node of the first center node doesn't exist, labeling the neighboring node of the first center node may be completed. For example, because unlabeled nodes having node values of 180, 185, 180 and 186 among the neighboring nodes of the first center node in FIG. 10C exist, the unlabeled neighboring node of the first center node may be labeled by performing steps S1020 to S1040 as described above. As a result, labeling all the neighboring nodes of the first center node may be completed.

Whether an unlabeled peak node in the touch data TD exists is determined in step S1080. For example, when an second peak node I2 is unlabeled after labeling the neighboring nodes of a first peak node I1 in FIG. 10E, the method of segmentation may perform steps from S1010 to S1070 to label the second unlabeled peak node I2. When segmenting the touch data TD having the plurality of peak nodes I1 and I2 having node values of 107 and 105 respectively in FIG. 10E, each of the plurality of peak nodes I1 and I2 may be assigned different labels. Accordingly, label A may be assigned to the peak node having the node value 107 and label B may be assigned to the peak node having the node value 105.

If there is no more unlabeled peak node in the touch data TD, the size or the position of the matrix may be changed in step S1090. For example, the size of the matrix M, M1 and M2 may be increased or the center position of the matrix M, M1 and M2 may be moved to include both at least one of labeled nodes and at least of unlabeled nodes in a region covered by the moved matrix M, M1 and M2 in step S1090. The center of the 3×3 matrix M may be moved to the node having the node values of 176 or 186 to label unlabeled nodes in FIG. 10C. Or, the size of the 3×3 matrix M may be increased to be 5×5 matrix having the same center node as that of the 3×3 matrix M.

After changing the matrix, whether the touch data TD includes an unlabeled node is determined in step S2000. If there is an unlabeled node in the touch data TD, the method of segmenting touch data TD may perform step S1020. If there is no more unlabeled nodes in the touch data TD as a result of searching the touch data TD by the changed matrix, segmenting the touch data may be completed. For example, if the current center node of the 3×3 matrix M moves to the node having the node value of 176 in FIG. 10C, steps S1020 to S1080 may be performed as described above to label unlabeled nodes in the matrix, i.e., 160, 165, 169 and 175. Other unlabeled node may be labeled in the touch data TD in FIG. 10C may be labeled in the same way. As a result of the labeling, if there is no more unlabeled node in the touch data TD, segmenting the touch data may be completed.

As described above according to the example embodiments, the method of segmenting touch data may perform segmenting large size of touch data with a small memory capacity and may avoid a memory overflow by starting labeling neighboring nodes of one of peak nodes in the touch data and gradually extending labeling region from the one of the peak nodes.

In addition, the method of segmenting touch data according to the example embodiments may reduce an operation time or an amount of operations by searching a peak node, determining a noise region in the touch data based on the peak node, and skipping segmenting the noise region based on a result of the determination.

FIGS. 10F and 10G is a flow chart of a method of segmenting touch data according to an example embodiment of the present inventive concepts. In FIG. 10F, the description about substantially same steps as FIG. 10A will be skipped for more convenient explanation.

Referring to FIGS. 10E to 10G, the method of segmenting may select a highest neighboring node of a current center node to labeling the nodes stored in the memory 130 whether or not the selected highest node is labeled or not in step S1032. For example, when a left-top node having a node value of 76 of the matrix M1 including a first peak node I1 in FIG. 10E is a current center node, the labeled highest node, the first peak node I1, may be selected as a highest neighboring node of the current center node having the node value of 76 in step S1032.

Whether the selected node is labeled or not is determined in step S1042. If the selected node is labeled, neighboring nodes corresponding to node information stored in the memory 130 may be assign the same label as a node label of the selected labeled node in step S1060. If the selected node is unlabeled, the selected node may be updated to the current center node and node information of the selected node may be stored in the memory 130 in step S1052. For example, when a node having a node value of 40 in FIG. 10E is the current center node, if a node having a node value of 101 is unlabeled, the neighboring node having the node value of 101 may be updated to the current center node and may be stored in the memory 130. When a node having a node value of 38 in FIG. 10E is the current center node, the selected neighboring highest node is a labeled node having a node value of 102 through steps S1010 to S1080. As a result, the current center node having the node value 38 may have the same label of a label of the selected labeled node having the node value of 102.

As described above according to the example embodiments, the method of segmenting touch data may define a first region based on touch data of a touch panel including a labeled peak node and one or more unlabeled neighboring nodes of the peak node, and label the one or more unlabeled nodes according to a label of the peak node. When the first region is completely labeled, size of the first region or a position of the first region may be changed to include another unlabeled node neighboring the first region.

The first region may be a region defined by a matrix and may change its size or position during the segmentation of touch data to include one or more unlabeled node and at least one labeled node in the first region. The first region may be defined as to include a plurality of nodes having a same label in the touch data. The first region may be extended to include one or more unlabeled node neighboring a labeled node in the touch data. In the extended region, one or more unlabeled nodes may be labeled according to the method of segmenting illustrated in FIGS. 10A to 10G.

As described above, a method of segmenting touch data according to the example embodiments may label an unlabeled neighboring node of a labeled peak node and may gradually extend a labeled region from the labeled peak node.

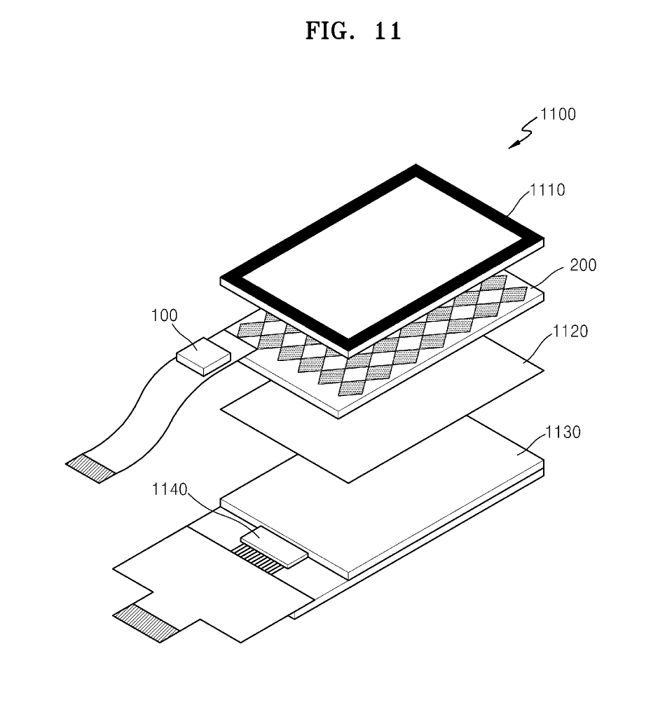

FIG. 11 is a view of a touch display device 1100 having a touch controller 100, according to one or more embodiments of the inventive concepts.

The touch display device 1100 may include a window glass 1110, a touch panel 200, and a display panel 1130. A polarizer 1120 may be arranged between the touch panel 200 and the display panel 1130 so that the touch display device 1100 may have optical properties. The window glass 1110 is formed of acryl, tempered glass, or the like, thereby preventing the touch display device 1100 from being scratched due to external impact or repeated touches.

The touch panel 200 may be formed on a glass substrate or a polyethylene terephthalate (PET) film by using transparent electrodes such as electrodes formed of indium tin oxide (ITO) and patterning the electrodes. The touch panel 200 may be formed of a capacitive-type touch panel and may transmit touch signals TS, which indicate a change in mutual capacitance of touched locations, to the touch controller 100.

The touch controller 100 receives the touch signals TS from the touch panel 200 and generates touch data TD. In addition, the touch controller 100 may assign labels to neighboring nodes by performing segmentation based on peak nodes of the touch data TD. The touch controller 100 may determine whether nodes are in a touch state by using an energy change in the touch data TD. When determining whether nodes are in a touch state, the touch controller 100 may select a peak node having a peak node value by searching for every node of the touch data TD. The touch controller 100 tracks the selected peak node based on state information of a peak node in a previous frame, determines a state of the selected peak node, and then performs segmentation of the touch data TD.

The touch controller 100 may perform the segmentation of the touch data TD based on the selected peak node. The touch controller 100 sets the selected peak node as a first center node and searches for a node having the lowest node value from among neighboring nodes of the first center node. Then, the touch controller 100 sets the node having the lowest node value as a second center node and may select a node having the highest node value from among unlabeled neighboring nodes of the second center node. The touch controller 100 sets the node having the highest node value as a third center node and may select a node having the highest node value from among unlabeled neighboring nodes of the third center node that have node values greater than the node value of the third center node. When there is no unlabeled neighboring node having a node value greater than the node value of the third center node, the selected nodes may be assigned the same label as the peak node.

The touch controller 100 may be mounted in a flexible printed circuit board (FPCB) as a chip-on-board (COB) type, wherein the FPCB is connected to a main board from the touch panel 200. According to embodiments, the touch controller 100 may be mounted in a main board of a graphic system.

The display panel 1130 may be formed of two sheets of glass that are attached to each other, wherein one sheet forms a top surface and the other does a bottom surface. A display driving device 1140 may be installed in the display panel 1130 as a chip-on-glass (COG) type. According to embodiments, the touch controller 100 and the display driving device 1140 may be integrated in one semiconductor chip.

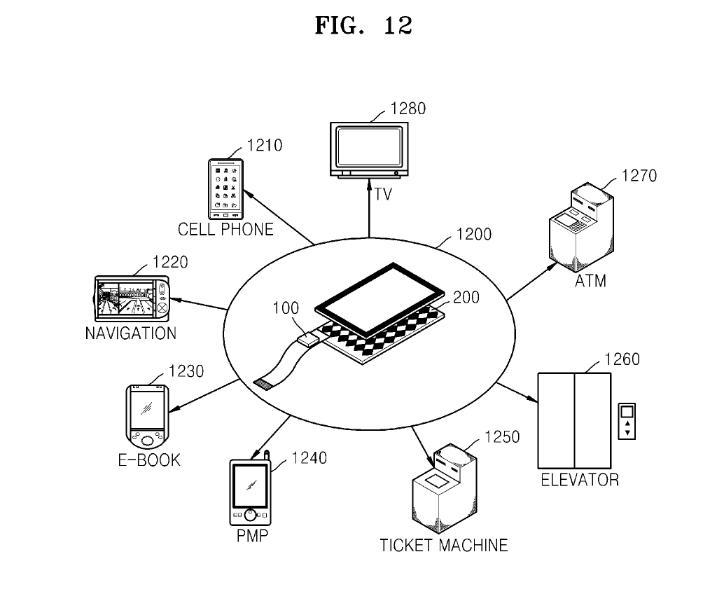

FIG. 12 illustrates a variety of products in which a touch sensor system 1200 including the touch controller 100 is installed, according to one or more embodiments of the inventive concepts.

Referring to FIG. 12, touch-screen type products may include the touch sensor system 1200 including the touch controller 100. The touch-screen type products are spotlighted in a mobile phone industry led by smartphones. The touch sensor system 1200 may include the touch panel 200 and the touch controller 100. The touch controller 100 generates touch data TD by receiving touch signals TS transmitted by the touch panel 200 and assigns labels to peak nodes having peak node values in the touch data TD in order to perform segmentation of the touch data TD based on the peak nodes.

The touch sensor system 1200 may be used as a touch display device in various fields where a user interface is necessary. The touch sensor system 1200 is applied to a mobile phone 1210 and may be variously used in TV 1220 having a touch screen, an automatic teller machine 1230 that deposits or withdraws money instead of tellers, an elevator 1240, a ticket issuing device 1250 used in subway stations, etc., a portable multimedia player 1260, an e-book reader 1270, a navigation device 1280, or the like.

The touch sensory system 1200 may use a method of segmenting touch data in order to accurately recognize a user's touch inputs applied on a touch display device. The method may include determining whether nodes are in a touch state based on an energy change of the touch data TD and selecting a peak node having a peak node value by searching for nodes of the touch data TD. State information about the peak node is tracked based on pieces of state information about a peak node in a previous frame, and segmentation of the touch data TD may be performed after a state of the peak node is determined.

In the description of the present invention, certain detailed explanations of the related art are omitted when it is deemed that they may unnecessarily obscure the essence of the invention.

While the inventive concepts has been particularly shown and described with reference to example embodiments thereof, it will be understood that various changes in form and details may be made therein without departing from the spirit and scope of the following claims.

What is claimed is:

1. A method of segmenting touch data comprising:
selecting a first peak node having a first peak node value in the touch data of a touch panel;
assigning a first label to the first peak node;
searching a first region including the labeled first peak node and at least one unlabeled neighboring node of the labeled first peak node; and
labeling the at least one unlabeled node in the first region according to the first label.

2. The method of claim 1, wherein the first region comprises a matrix including the first peak node and the at least one unlabeled neighboring node of the first peak node.

3. The method of claim 1, wherein labeling the at least one unlabeled neighboring node comprises:
updating a current center node;
storing node information of the current center node in a memory;
selecting a labeled highest neighboring node of the current center node; and
assigning the first label to the current center node based on the node information stored in the memory.

4. The method of claim 3, wherein labeling the at least one unlabeled neighboring node further comprises:
invalidating one or more unlabeled nodes based on the node information stored in the memory if a memory overflow occurs when the node information is stored in the memory; and
emptying the node information from the memory.

5. The method of claim 3, wherein updating a current center node in the first region comprises:
selecting an unlabeled lowest neighboring node of the first peak node; and
setting an selected unlabeled lowest neighboring node to the current center node.

6. The method of claim 3, wherein updating a current center node in the first region comprises:
selecting an unlabeled highest neighboring node of the current center node; and
setting the selected unlabeled highest neighboring node to the current center node.

7. The method of claim 1, further comprising:
emptying node information stored in the memory after labeling the at least one unlabeled nodes in the first region.

8. The method of claim 1, further comprising:
changing the size of the first region or moving the position of the first region to include at least one node labeled with the first label and at least one of the unlabeled nodes in the touch data.

9. The method of claim 1, further comprising:
selecting a second peak node having a second peak node value in the touch data;
assigning a second label to the second peak node;
searching a second region including the labeled second peak node and at least one unlabeled neighboring node of the second peak node; and
labeling the at least one unlabeled node in the second region according to the second label.

10. The method of claim 1, further comprising:
tracking the first peak node based on state information of one or more peak nodes in a previous frame of the touch data; and
determining a state of the first peak node.

11. The method of claim 10, wherein the determining a state of the first peak node comprises:
classifying the state of the first peak node into a no-touch state, a noise state, a touch state, or a pending state based on the first peak node value, a first threshold value and a second threshold value,
wherein the first threshold value is a first reference to indicate whether a touch on the touch panel occurs and the second threshold value is a second reference to indicate whether the touch panel is fully touched, wherein the second threshold value is greater than the first threshold value.

12. A touch sensor system comprising:
a touch panel; and
a touch controller configured to receive touch signals from the touch panel, generate touch data based on the touch signals, assign a label to a peak node having a peak node value in the touch data, and perform segmenting the touch data,
the touch controller configured to select an unlabeled node in a first region including the labeled peak node and at least one unlabeled neighboring node of the labeled first peak node, store the selected unlabeled node, and label the selected unlabeled node in the first region according to the label.

13. The touch sensor system of claim 12, wherein the first region comprises a matrix including the first peak node on a center of the matrix and the at least one unlabeled neighboring node of the first peak node.

14. The touch sensor system of claim 12, wherein the selected unlabeled node is a node having the lowest node value neighboring the first peak node.

15. The touch sensor system of claim 12, wherein the selected unlabeled node is a node having the highest node value neighboring a current center node.

16. A method of labeling an unlabeled node in touch data comprising:
selecting a first peak node as a first center node in the touch data of a touch panel;
assigning a first label to the first peak node;
defining a first region including the first peak node and an unlabeled neighboring node of the first peak node;
labeling the first region according to the first label; and
extending the first region to include one or more unlabeled nodes in the touch data.

17. The method of claim 16, wherein the first region comprises a matrix including the first peak node on a center in the matrix and the unlabeled neighboring node of the first peak node.

18. The method of claim 16, wherein labeling the first region comprises:
selecting an unlabeled node in the first region as a current center node;
storing node information of the current center node in a memory;
selecting a labeled node having the highest node value neighboring the current center node; and
assigning the first label to the unlabeled node based on the node information stored in the memory.

19. The method of claim 18, wherein labeling the first region further comprises:
selecting an unlabeled node having the highest node value among neighboring nodes of the current center node;
storing node information of the selected unlabeled node having the highest node value; and
setting the selected unlabeled node having the highest node value to the current center node.

20. The method of claim 18, further comprising:
emptying node information stored in the memory after assigning the first label to the unlabeled node.
